(19) United States
(12) Patent Application Publication
(10) Pub. No.: US 2002/0159702 A1
(43) Pub. Date: Oct. 31, 2002

(54) Optical mach-zehnder interferometers with low polarization dependence

(75) Inventors: Alice Liu, San Jose, CA (US); Kenneth McGreer, Fremont, CA (US); Wenjie Chen, Cupertino, CA (US); Wayne Wai Wing Lui, Fremont, CA (US)

Correspondence Address: MORRISON & FOERSTER LLP, 755 PAGE MILL RD, PALO ALTO, CA, 94304-1018, US

(73) Assignee: Lightwave Microsystems Corporation, San Jose, CA

(21) Appl. No.: 10/059,674

(22) Filed: Jan. 30, 2002

Related U.S. Application Data
(60) Provisional application No. 60/276,644, filed on Mar. 16, 2001.

(51) Int. Cl. G02B 6/26

(52) U.S. Cl. 385/40; 385/39; 385/140

(57) ABSTRACT

This relates generally to optical waveguide-based devices including dynamically programmable optical attenuators. In particular, this provides an optical attenuator having a Mach Zehnder configuration with reduced polarization dependence. The devices herein facilitate the implementation of continuously-variable optical attenuators, optical shutters, and optical switches in an integrated photonic circuit.

### TECHNICAL FIELD

This invention relates generally to optical waveguide-based devices including dynamically programmable optical attenuators. In particular, this invention provides an optical attenuator having a Mach Zehnder configuration with reduced polarization dependence. Application of the invention facilitates the implementation of continuously-variable optical attenuators, optical shutters, and optical switches in an integrated photonic circuit.

### BACKGROUND OF THE INVENTION

Variable optical attenuators (VOA's) are used to adjust the signal levels between components of a fiber optic communication system, where optical signal power must be managed carefully. Some VOA's are optical devices which can be inserted into a fiber optic system either by splicing or using connectors. These VOAs adjust the intensity of the light, i.e., the optical power, in the fiber to provide uniformity of optical power for each channel of the optical system. A dynamically programmable VOA is capable of varying the amount of attenuation in response to a control signal.

Most commercially-available variable attenuators on the market are mechanical, relying on the movement of an optical fibers, mirrors, prisms, graduated neutral density filters and the like to achieve attenuation. Such approaches are prone to mechanical failure, and are often not looked upon favorably by fiber optic system designers.

Photonic devices for optical network management and wavelength multiplexing and demultiplexing applications have been extensively researched for a number of years. A significant class of such devices is commonly called “planar lightwave circuits or just PLC's. PLC's comprise technologies wherein complex optical components and networks are disposed monolithically within a stack or stacks of optical thin films supported by a common mechanical substrate such as a semiconductor or glass wafer. PLC's are typically designed to provide specific transport or routing functions for use within fiberoptic communications networks. Since optical signals do not require return paths, these waveguide configurations do not typically conform to the classic definition of “circuits”, but due to their physical and functional resemblance to electronic circuits, the waveguide systems are also often referred to as circuits.

The standard family of materials for PLC's, widely demonstrated to have superior loss characteristics, is based on silicon dioxide (SiO2), commonly called silica. The silica stack includes layers that may be pure silica as well as layers that may be doped with other elements such as Boron, Phosphorous, Germanium, or other elements or materials. The doping is done to control index-of-refraction and other necessary physical properties of the layers. Silica, including doped silica, as well as a few less commonly used oxides of other elements, are commonly also referred to collectively as “oxides.” Furthermore, although technically the term “glass” refers to a state of matter that can be achieved by a broad spectrum of materials, it is common for “glass” to be taken to mean a clear, non crystalline material, typically SiO2 based. It is therefore also common to hear of oxide waveguides being referred to as “glass” waveguides. Subsequently, the moniker “silica” is used to refer to those silicon oxide materials suitable for making waveguides or other integrated photonic devices. It is important to note that in the context of this invention, other waveguide materials, such as lithium niobate, spin-on glasses, silicon, siliconoxynitride, or polymers, are also appropriate.

A key performance issue in the practical application of optical devices is the efficiency of the device in transporting the optical energy of the signal. This performance is characterized in terms of the fraction of energy lost from the signal passing through the device, expressed as “loss” or “attenuation” in units of decibels (dB) or “loss rate” or “attenuation rate” in units of dB/cm. Typically, the optical power emerging from an optical attenuator is less than the optical power entering the optical attenuator, in which case the attenuation has a positive value according to the sign convention adopted herein. The attenuation of a variable attenuator in its least-attenuating state is defined as the “insertion loss” of the device, and the additional amount of attenuation achievable between that insertion loss and the maximum designed attenuation is defined as the “dynamic range.” Desirable insertion loss is near zero, and desirable dynamic range is from 10 dB to 50 dB and sometimes greater, depending on the intended use of the device. Another key performance issue is the “polarization dependent loss” (PDL). This quantity is the difference between the maximum loss and minimum loss attained when measured for all input polarizations of light. For most VOA's it is desirable to minimize PDL, typically below 0.5 dB throughout the attenuation range.

One example of a PLC attenuator is a thermal-optic switch constructed using a Mach-Zender (MZ) configuration. Devices having a MZ configuration are disclosed in U.S. Pat. Nos. 5,044,715; 5,956,437; 5,881,199 and PCT Publication WO/99/24867. The entirety of each of these references being incorporated by reference herein.

A VOA using a MZ configuration is depicted schematically in FIG. 1A in which two waveguides A, B have ports 10A, 10B, 12A and 12B, and coupling regions 14, 16. Between the coupling regions, each waveguide A, B includes phase shifting region 18A, 18B. The phase shifting regions 18A, 18B of each of the waveguides A, B constitute the two interference arms of the MZ configuration. The coupling regions 14, 16 are separated by a distance D which is proportional to a coupling coefficient. The coupling coefficient along with the coupling length, i.e., the length of the coupling regions 14, 16, predicts the amount of light “leaked” from one waveguide to another. The phase shifting regions 18A, 18B permits the introduction of a phase difference between the light travelling in each waveguide A, B by variation of the optical path length of the regions 18A, 18B. The term ‘optical path length’ refers to the product of i) the physical length of the waveguide in which light propagates; and ii) the effective refractive index of light propagating in the guide.

The VOA described above may be configured to perform various functions. For instance, given an input optical signal provided in port 10A, the VOA will ideally distribute optical power between ports 12A and 12B. Used herein, the term ‘bar path’ refers to the path of the optical signal transmitted from ports 10A to 12A. Also, the term ‘cross path’ refers to the path of the optical signal transmitted from ports 10A to 12B.

Accordingly, if the optical path lengths of these interference arms 18A, 18B are equal, and the couplers split light intensity exactly in half (3 dB couplers), then all light launched into port 10A of the configuration emerges from port 12B, the cross path. If the arms of the phase shifting regions 18A, 18B are of unequal optical path length, then the light that is launched into port 10A is shared between ports 12A and 12B in a ratio determined by the difference in phase introduced by the difference in optical path length and by the coupling ratio.

For any given wavelength, increasing the optical path length difference will cause the proportion of the light reaching port 12B from port 10A to vary according to a raised cosine characteristic. If the power from port 10A that emerges by way of port 12A is absorbed or otherwise disposed of, the optical coupling between port 10A and port 12A can be viewed in terms of the configuration acting as an optical attenuator. By adjusting the optical path length, either by increasing the physical length or by increasing the effective refractive index the MZ can relay the optical signal from 10A to either 12A, known as the bar path, or to 12B, known as the cross path. One common way to adjust the increase of the effective refractive index of the interference arms 18A, 18B is through the use of heaters 20A, 20B placed along the interference arms 18A, 18B. Although the figure illustrates heaters on both interference arms 18A, 18B, a heater may be placed on only one of the two arms. In any event, temperature increase introduced by the heaters, induces a refractive index difference between the two arms 18A, 18B and provides a phase shift between the light traveling in each respective arm.

However, many of the characteristics of a VOA device are polarization dependent. For example, the coupler length corresponding to a particular ratio of transmitted optical power is dependent upon the state of polarization. FIG. 2A illustrates an ideal graph (i.e., no polarization dependence) of the bar path 22 and cross path 24 for the percentage of transmitted power versus the normalized coupling length. Point 26 depicts the 3 dB coupling point at which the balance is equal to zero. Where the coupling balance is defined by the following equation:

coupling balance=−10 log(P₁/P₂);

Where P1 represents the optical power emerging from the bar path, and P2 represents the optical power emerging from the cross path.

As illustrated in FIG. 2B, the 3 dB point has a different coupling length depending on the polarization of the light because of the different coupling balances for the different polarizations. As illustrated in FIG. 2B, 22′ and 22″ correspond to the respective TM and TE polarizations for the bar path 22. While 24′ and 24″ correspond to the respective TM and TE polarizations for the cross path 22. It should be noted that the TM and TE polarizations are examples only. The polarization states do not necessarily have to be TE or TM. Instead, the curves can represent other polarization states that give maximum insertion loss and minimum insertion loss. As indicated, the 3 dB point corresponds to different normalized coupling lengths for the different polarizations. FIG. 2C illustrates a graph of balance versus the normalized coupling length using the data from FIG. 2B. As shown in the expanded graph area of FIG. 2C, there is a variation in the balance between the TM polarization curve 28 and the TE polarization curve 30 depending upon the normalized coupling length. This difference between the curves 28 and 30 is called the polarization dependent balance (PDB) and is defined, for example, by the following equation:

PDB=balance_TM−balance_TE

Again, it is important to note that PDB is not limited to TM versus TE. Instead, PDB can be defined by the polarization states that determine the highest balance and the polarization states that determine the lowest balance.

The PDB affects the insertion loss (IL) of the device. For example; prior VOA's are designed to have a balance of zero. FIG. 2D illustrates a graph of insertion loss (IL) versus the phase for the bar and cross paths for a device where the balance equals 0 dB. FIG. 2E illustrates a similar graph of IL versus phase for the bar 32 and cross 34 paths where the balance is not equal to zero due to PDB. As shown in the graph, the IL for both paths 32, 34 are degraded.

Polarization dependence also affects the phase change for the light transmitted in device. The change in the refractive index given a change in temperature (dn/dT) is referred to as the thermooptic coefficient. This thermooptic coefficient can be polarization dependent due to such factors as anisotropic thermal profiles, thermal expansion stresses in the waveguide, and the birefringence of the materials. Accordingly, given a desired temperature change, the resulting phase change for TE polarized light is not the same as the resulting phase change for TM polarized light. Thus, the phase change of the light depends upon its polarization.

Furthermore, polarization dependence also affects the IL for the device. As shown in FIG. 2F, in a device where the length of the interference arms is equal, the polarization effects yield different IL for different polarizations. The polarization dependent loss (PDL) is measured as the difference between the two curves. For example, the bar path PDL is measured as the separation between the two curves 32′ and 32″ while the cross path PDL is the separation between the two curves 34′ and 34″. In each case, the curves will exhibit a horizontal separation component and a vertical separation component.

VOA's are often constructed of materials which increase the polarization dependence. For example, in materials such as glass, the thermooptic coefficient is small enough and the thermal conductivity is large enough such that inducing the needed phase shift requires power as high as >500 mW. Since, as described above, the thermooptic coefficient and balance are polarization dependent, the more power used to induce a phase shift, the more the device becomes polarization dependent.

Accordingly, there remains a need to provide a MZ with reduced polarization dependent effects.

### SUMMARY OF THE INVENTION

In this invention, a device is described that is comprised of a waveguide and a coupling layer. Varying amounts of heat are applied to the structure to control the attenuation rate. These attenuators can be made in arrays and integrated with other optical devices on a single substrate such that substantial cost savings are achieved over connecting an equal number of discrete devices.

The invention includes an optical device having a MZ configuration in which a coupler balance and the phase difference between interference arms is selected to match the insertion loss of different polarizations of light over an attenuation range.

The invention includes controlling polarization dependent loss (PDL) through control and design of the coupler balance and of the geometry of the interference arms in the phase shifting region of the device. In one variation, the coupler balance is selected to be a non-zero value and the difference in optical path length of the interference arms is configured to induce a non-zero phase difference. By non-zero phase difference we mean include a non-zero optical path length difference.

Variations of the device include adjusting the length and/or width of waveguides within the coupling region to control coupling balance. The invention also includes adjusting the gap between waveguides within the coupling region to control coupling balance.

In another variation of the invention, it is not necessary for the couplers to split light for the MZ. Instead, the invention may include the use of a Y junction, for example. Accordingly, the invention may be applied to minimize PDL for a MZ consisting of two Y junctions connected by phase shifting arms.

Another variation of the invention includes adjusting the optical path length of the interference arms through control of the geometry of the waveguides. Varying the geometry of the waveguides includes varying the length and/or width of the waveguides.

In another variation of the present invention, the optical path length of the interference arms is adjusted, as described herein, along with adjustment of the coupling balance, as described herein, to control PDL.

Another variation of the invention includes a combination variable optical attenuator system, the combination comprising at least one variable optical attenuator as described herein, the attenuator being disposed on a substrate; and, an optical device disposed on the substrate and in optical communication with the attenuator, the optical device being selected from the group consisting of optical switches, passive waveguides, arrayed waveguide grating wavelength multiplexers and demultiplexers, waveguide optical amplifiers, and optical waveguide splitters.

Yet another variation of the invention includes an array of variable optical attenuators comprising a plurality of input waveguides disposed in parallel on a substrate, a plurality of attenuators, each as described herein and optically connected to a corresponding input waveguide; and a plurality of output waveguides optically connected to a corresponding attenuator.

The invention further includes a method of reducing polarization dependence in a variable optical attenuator device having a Mach Zehnder configuration, where the variable optical attenuator includes a first and second optical waveguide for transmitting an optical signal in each respective waveguide, at least one coupling region, and a phase shifting region between said coupling region, the method comprising configuring at least one coupling region to have a non-zero coupler balance where the coupler balance is defined by a logarithmic ratio between optical power of optical signals in the first and the second waveguides and selecting an optical path difference between the first waveguide and the second waveguide to induce a non-zero phase difference between optical signals.

Another variation of the invention includes the method described above where configuring at least one coupling region comprises configuring a coupling length, a coupling width, a coupling gap, or a combination thereof to achieve the non-zero coupler balance.

Yet another variation of the invention includes the method described above where selecting an optical path difference between the first waveguide and the second waveguide comprises configuring a width, a length, or a combination thereof to induce the non-zero phase difference.

### BRIEF DESCRIPTION OF THE DRAWINGS

FIGS. 1A illustrates a schematic of an optical attenuator having a Mach Zehnder configuration.

FIG. 1B illustrates a cross sectional illustration of an optical waveguide.

FIG. 2A illustrates an ideal graph of the bar path and cross path for the percentage of transmitted power versus the normalized coupling length.

FIG. 2B a graph showing the polarization dependence of the percentage of transmitted power versus the normalized coupling length.

FIG. 2C illustrates a graph showing coupler balance.

FIG. 2D illustrates a graph of insertion loss (IL) versus the phase for the bar and cross paths for a device where the balance equals 0 dB.

FIG. 2E illustrates a graph of IL similar to that shown in FIG. 2D, where the balance is not equal to zero plus delta.

FIG. 2F illustrates the polarization effects in a graph of IL versus phase in a device where the length of the interference arms is equal.

FIGS. 3A-3C illustrate various examples of the VOA of the present invention.

FIGS. 4A-4B illustrate design windows for examples of the present invention.

### DETAILED DESCRIPTION OF THE INVENTION

Several embodiments are discussed below and with reference to the attached drawings. These descriptions and drawings are for explanatory purposes and do not exhaustively represent all combinations of waveguide, coupling layer, and material configurations provided by this invention. Those skilled in the art will readily appreciate that many other variations could be derived originating from these descriptions and cited technical findings without further invention. For instance, extension of the attenuator principles disclosed herein may be possible to such fields as MEMS and microfluidics. The below-described examples embody certain principles of the invention that are described above and herein, but the examples are not to be interpreted as limiting the scope of the claims to the specific examples described herein. Instead, the claims are to be given their broadest reasonable interpretation in view of the description herein, the prior art, and the knowledge of one of ordinary skill in this field. Attenuation as described herein relates to the fraction of energy lost from a signal passing through a device, as discussed in detail above, as opposed to a complete loss of energy during signal transfer. An attenuator may also be configured to act as a shutter in order to prevent an optical signal from being transmitted, i.e., the attenuator may not only attenuate, but may also act as a shutter.

An exemplary device of the present invention may be made by first creating a silica waveguide using the following process: An undoped SiO2 silica lower cladding layer, typically 15-30 μm thick, is deposited or oxidized on a silicon substrate. This lower cladding layer has a refractive index of approximately 1.445. A core layer is then deposited on top of the lower cladding, using standard silica deposition techniques such as flame hydrolysis or plasma-enhanced chemical vapor deposition (PECVD). This core is silica with one or more dopants such as boron, germanium and/or phosphorus, and has refractive index approximately 0.5% to 1% higher than the cladding index. The core layer is approximately 5-8 μm thick. The core layer is patterned using photolithography and reactive ion etching, often incorporating an intermediary hard mask layer such as chrome, to define a waveguide core of rectangular cross section. After the core is etched, a silica upper cladding layer (e.g., doped with one or more of the above-mentioned dopants) is deposited on the structure. An optional upper cladding layer has the same refractive index as the lower cladding layer, and is created in either doped or undoped silica. The waveguide is preferably designed to be single-mode, although the principles described herein can also be extended to multi-mode operation.

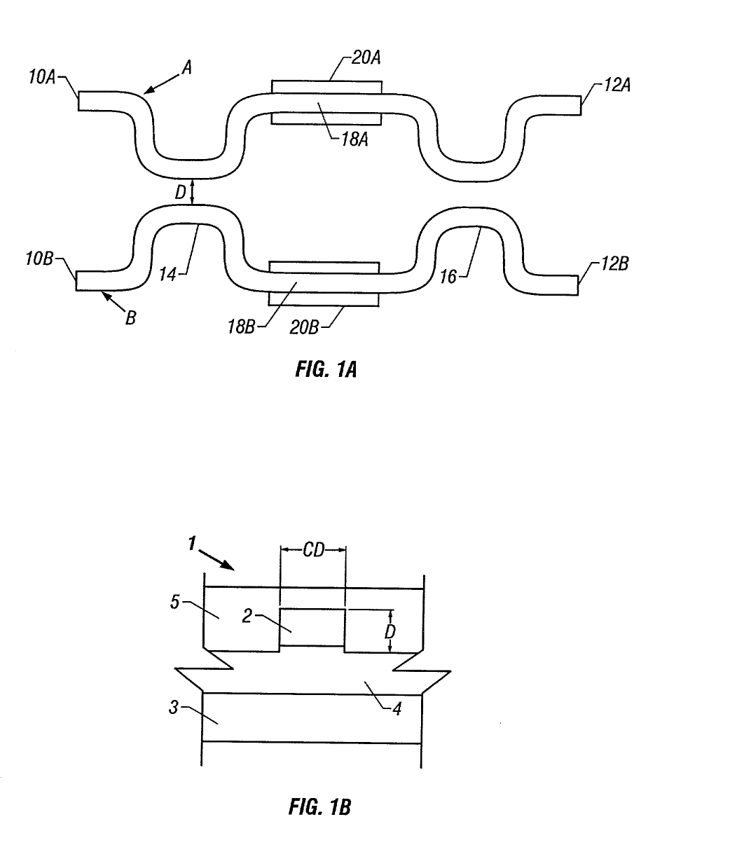

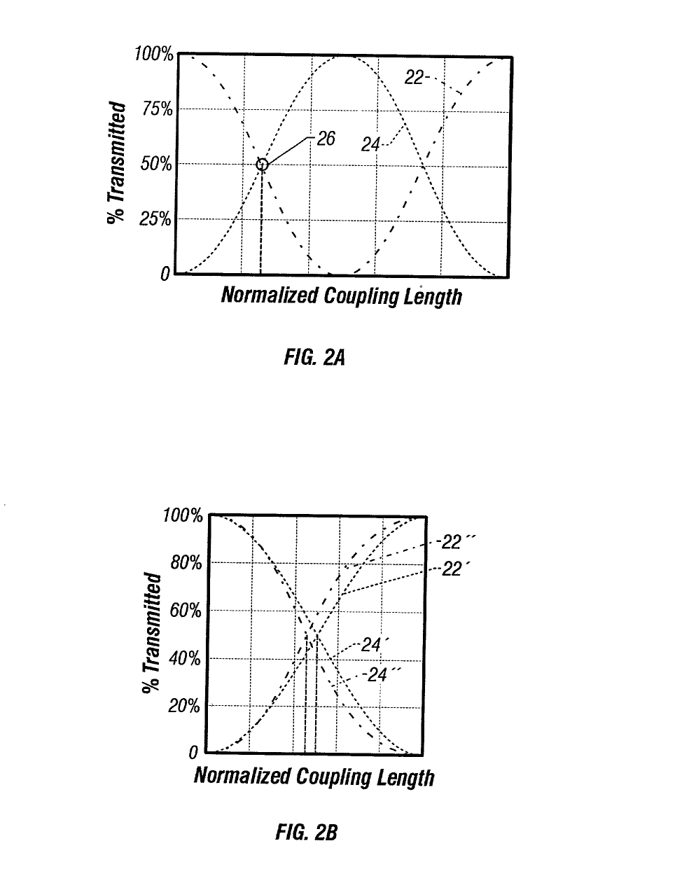

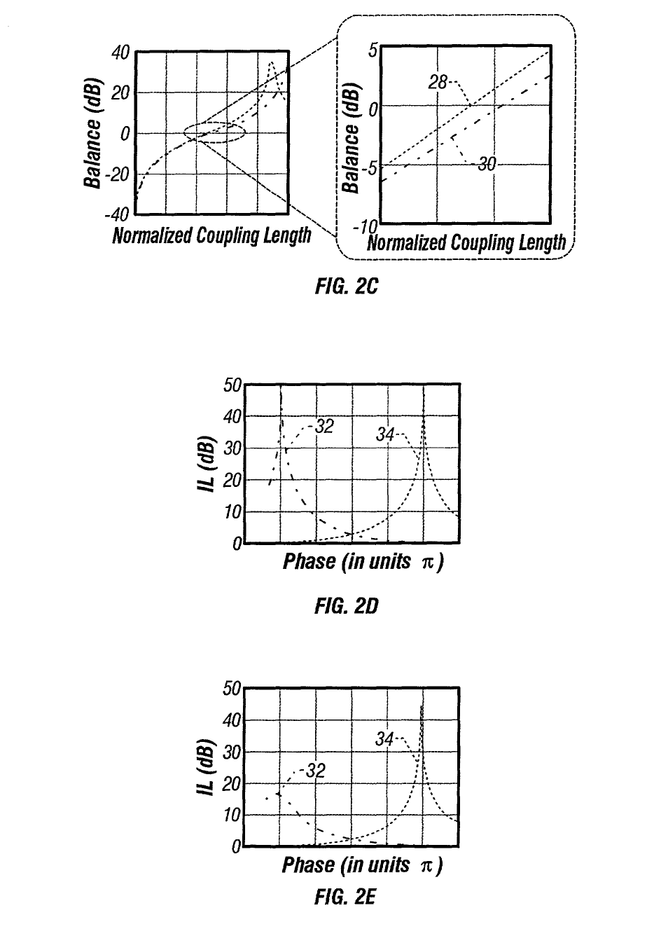

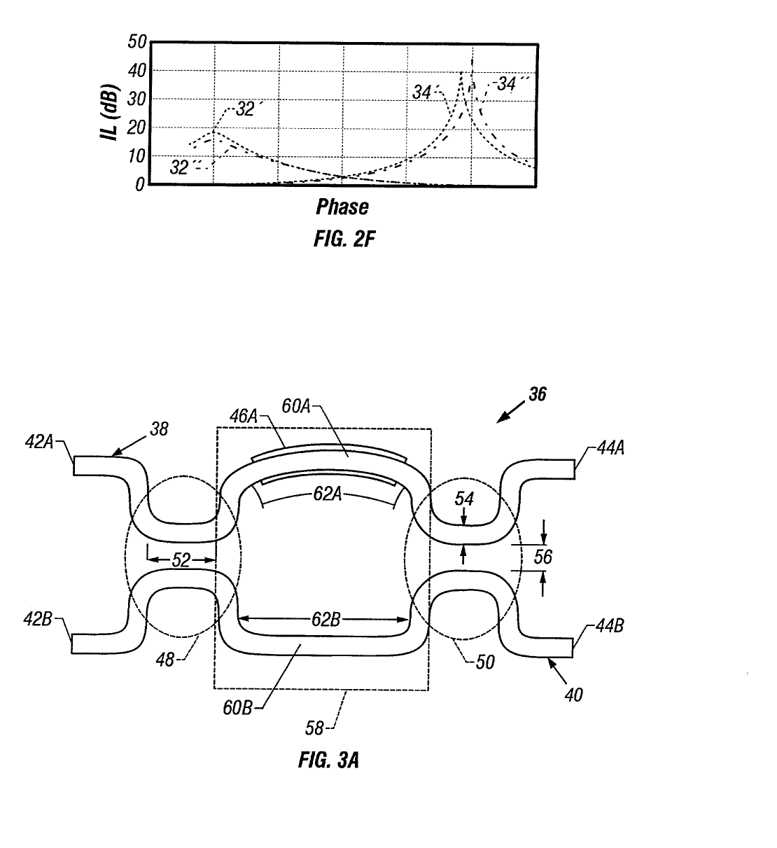

FIG. 1B illustrates a cross section of a waveguide 1 on a PLC 1. FIG. 1B illustrates a substrate 3 with a lower cladding 4 deposited on the substrate 3 and a waveguide 2 on the lower cladding 4. As illustrated in FIG. 1D, the waveguide 2 is covered by a top cladding layer 5, which may have the same index as the lower cladding layer 4. As shown, in FIG. 1B, the waveguide 2 will have a width CD and depth D wherein the depth is controlled by the amount of cladding deposited on the substrate during fabrication.

As discussed above, the waveguide materials and coupling layer material can have different thermal response, described by the quantity dn/dT which is the change in refractive index when the material undergoes 1° C. temperature change. In this example, the silica waveguide core and cladding materials have dn/dT of approximately 2×10⁻⁵/° C.

The optical path length adjusters may include thin-film metal resistive heaters which are patterned over the silica waveguide. The configuration may include one heater on each side of the waveguide, to provide local heating such that the temperature of the polymer and waveguide in the vicinity of the waveguide core can be increased. Examples of optical path length adjusters include thermal (as described above), acoustic, electric-field, current, etc.

The invention described herein provides an optical device using a MZ configuration for attenuating an optical signal where the optical device is configured to provide reduced polarization dependence. The invention reduces polarization dependence through control of the coupler balance and/or through control of the difference in optical path length of the interference arms. Although it is preferable to reduce polarization dependence in a single device by controlling both the coupler balance and the optical path length difference, the invention also includes controlling either of these parameters in a device to achieve reduced polarization dependence.

In the MZ of the invention described herein, there may be a geometric difference between the arms of the MZ. The geometric difference may be introduced by introducing different lengths for each MZ arm. Alternatively, the geometric difference may be introduced by introducing a different width for each arm. In any case, the geometric difference between the arms of the MZ is selected to minimize the polarization as described below. For configuration of the device to have a pre-determined phase bias, the optical paths of the interference arms are designed to have a difference which induce a non-zero phase difference between optical signals in the waveguides of the VOA.

The device of the present invention may have a zero-voltage state between the maximum and minimum attenuation point. As a result, less energy is required to adjust the interference arms to achieve either the maximum or minimum attenuation. It follows that since less energy is required, the effects of the polarization dependence introduced by heating are thereby reduced. In another example, configuring the device to have a pre-determined non-zero coupler balance as described below, allows for minimization of the PDL. Through experimentation it was found that the PDL can be: <0.2 dB @ 0 dB attenuation; <0.6 dB @ 10 dB attenuation; and <1.4 dB @ 15 dB attenuation. Additionally it was found that power consumption is less than 350mW per channel.

The invention further includes designing the zero voltage attenuation point somewhere between the maximum and minimum attenuation and heating one arm to achieve higher attenuation or heating the other arm to achieve lower attenuation. Accordingly, providing such an improved device allows a reduction of the maximum power consumption for inducing a particular phase change. Achieving a reduction of maximum power consumption (e.g., up to 50%) is possible with such an improved design. Moreover, because of the reduction of the maximum power consumption, the polarization dependence of the device is reduced as well.

By zero-voltage state we mean the state in which zero voltage is applied to each optical path length adjuster. By zero-voltage attenuation we mean the attenuation obtained where zero voltage is applied to each optical path length adjuster.

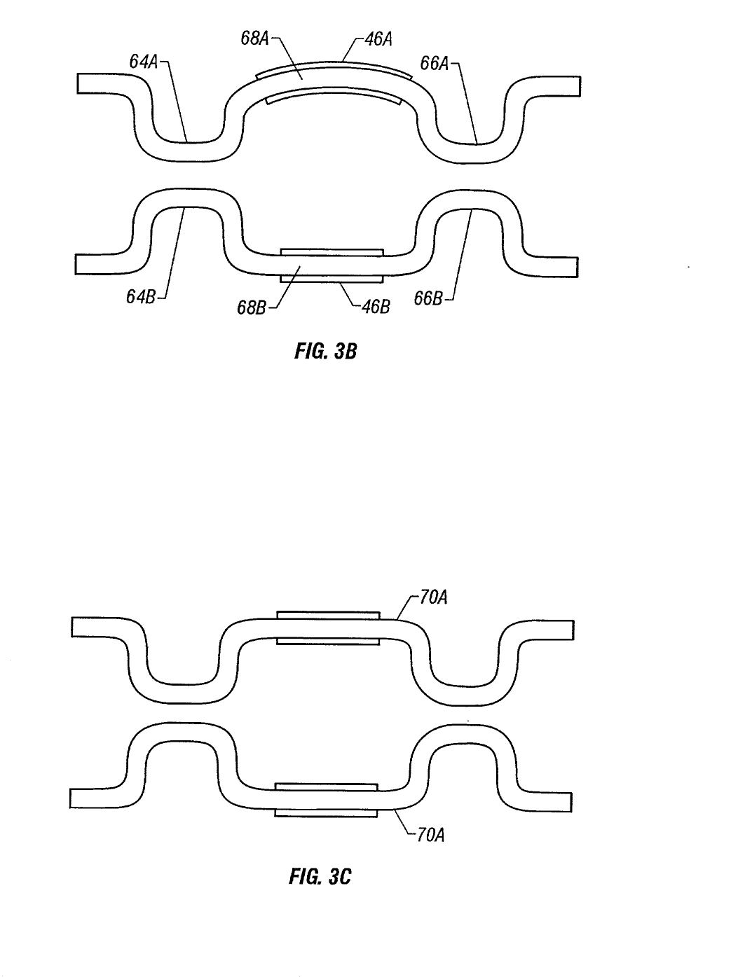

FIG. 3A illustrates a schematic example of the present invention. The illustrated device 36 includes an electrically controllable device having a Mach Zehnder configuration for attenuating an optical signal. The device 36 includes a first optical waveguide 38 and a second optical waveguide 40. Each optical waveguide 38,40 includes an input ports 42A, 42B and output ports 44A, 44B.

The devices of the present invention include at least one optical path length adjuster 46A, 46B. Although the device 36 of FIG. 3A illustrates optical path length adjuster 46A on one waveguide 38, the device may include a path length adjuster on both of of the waveguides. The path length adjuster may provide heat to the waveguide thereby affecting the refractive index of the waveguide. As discussed elsewhere, the change of refractive index given a change in temperature is called the thermooptic coefficient. It is understood that the thermooptic coefficient is polarization dependent because of stresses introduced by the mismatch of thermal expansion coefficients in the waveguide and cladding layers. Therefore, a larger increase in temperature will effect a larger effect between the light of different polarizations within the waveguides. Examples of the path length adjusters include thin film heaters, acoustic, light, electric field, current, etc.)

The device 36 further includes at least two coupling regions 48, 50 capable of coupling the input port 42A of the first optical waveguide 38 with said output port 44B of the second optical waveguide 40. This path (42A to 44B) is referred to the cross path. As is evident, the device 36 may also couple light from 42A to 44A, (such a path being referred to as the bar path.)

The length of the waveguides in the coupling region 48, 50 is referred to as the coupling length 52. The width of the waveguides in the coupling region 48, 50 defines a coupling width 54. The distance between the optical waveguides in each coupling region 48, 50 defines a coupling gap 56. The coupling length, coupling width and coupling gap affects a coupler balance of said device. The coupling balance being previously defined.

The device 36 further includes a phase shifting region 58 between the coupling region 48, 50. The phase shifting region 58 includes two interference arms 60A, 60B. Usually, the arms 60A, 60B are optically in parallel and each has an optical path arm length. As defined above, the optical path length is often referred to as the product of the physical length of the waveguide in which light propagates; and the effective refractive index of light propagating in the guide. However, the optical path length of the arm is also affected by the width of the arms. The width of the arms has an effect on the refractive index. Accordingly, a change in the width of the arms causes a change in the effective refractive index which causes the change in the optical path length of the arm. As shown in FIG. 3A, the interference arm 60A of one of the waveguides 38 is longer than the interference arm 60B of the other waveguide 40. The difference in the optical path arm lengths affects the phase difference between optical signals in the arms 60A, 60B.

In the present invention, the coupling length, coupling width, and coupling gap are configured to induce a non-zero coupler balance for the device. While the difference in optical path arm lengths is configured to induce a non-zero phase difference. Example of the values for these characteristics is found below.

FIG. 3B illustrates another variation of the invention. In this variation, the optical coupling regions contain waveguides 64A, 66 A having different widths than the opposing waveguides 64B, 66B. In this variation, both waveguides contain optical path length adjusters 46A, 46B.

FIG. 3C illustrates another variation of the invention. In this example, the interference arms 70A, 70B have different widths.

The invention further includes the method of reducing polarization dependence in a variable optical attenuator device as described herein.

The following two examples provide variations of MZ VOA's of the present invention. In the first example, the cross path is used as the output. In the second example, the bar path is used as the output.

Cross Path Example

Assuming that the two couplers of the MZ interferometer are sufficiently similar, the equations governing the light transmission to the cross path for both polarizations of the MZ is:

$${I}_{TE}^{⊗} ≅ {sin}^{2} ( 2 {φ}_{TE} ) {cos}^{2} ( \frac{{Δϕ}_{TE}}{2} )$$

$${I}_{TM}^{⊗} ≅ {sin}^{2} ( 2 {φ}_{TM} ) {cos}^{2} ( \frac{{Δϕ}_{TM}}{2} )$$

Where Φ_{TE} and Φ_{TM} are functions of the coupling coefficient and coupler length. For example see R. Marz, “Integrated Optics Design and Modeling,” Artech House, Norwood Mass., USA, 1995.

For a 3dB coupler, Φ=π/4. Δφ is the thermally induced optical phase difference between light traveling in the arms of the MZ, and it is a function of thermooptic coefficient and temperature:

$$Δϕ = ( \frac{2 π}{{λ}_{0}} ) L \frac{ⅆ n}{ⅆ T} Δ T + {ϕ}_{bias}$$

Where n is the effective index of the waveguide, T refers to the temperature, and ^{dn}/_{dT} is polarization dependent. φ_{bias} is the phase difference which is induced by an optical path length difference between the arms in the zero voltage state. λ₀ is the free space wavelength. The amount of polarization dependence in Δφ depends on both of these terms. However, since φ_{bias} may be selected as discussed herein, the introduction Of φ_{bias} reduces the polarization dependent effects of ^{dn}/_{dT}.

The polarization dependent loss (PDL) of the Mach Zehnder at various attenuation points is defined as:

$$PDL ( dB ) = - 10 log [ \frac{{I}_{TM}^{⊗}}{{I}_{TE}^{⊗}} ] = - 10 log [ \frac{{sin}^{2} ( 2 {φ}_{TM} ) {cos}^{2} ( \frac{{Δϕ}_{TM}}{2} )}{{sin}^{2} ( 2 {φ}_{TE} ) {cos}^{2} ( \frac{{Δϕ}_{TE}}{2} )} ]$$

The PDL becomes more sensitive as Δφ goes from 0 to II. Typically,

$${( \frac{ⅆ n}{ⅆ T} )}_{TM} > {( \frac{ⅆ n}{ⅆ T} )}_{TE} . So for 0 < Δϕ < π , {cos}^{2} ( \frac{{Δϕ}_{TM}}{2} ) < {cos}^{2} ( \frac{{Δϕ}_{TE}}{2} ) . ]$$

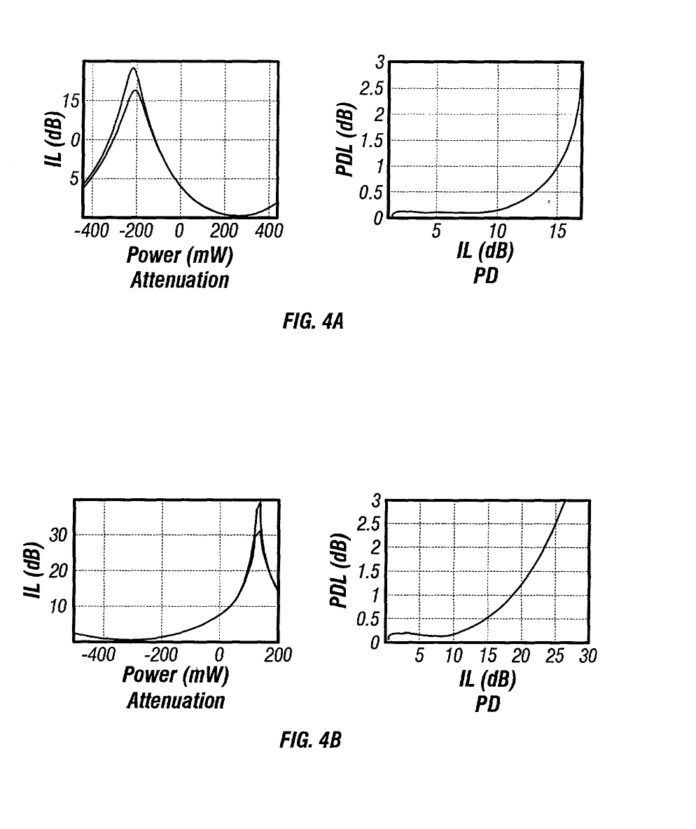

In order to have low PDL, for this example, it is necessary that sin² (2Φ_{TM})>sin²(2Φ_{TE}). Typically, for a fixed coupler length, Φ_{TM}>Φ_{TE} due to stress birefringence built in within the coupler. In order for sin²(2Φ_{TM})>sin²(2Φ_{TM}) to be true, for this example, it is necessary that Φ_{TE}<Φ_{TM}<II/4. This means, for this example, that the couplers need to be undercoupled (i.e. more light emerges from undercoupled (i.e. more light emerges from the top output than from the bottom output). The amount of PDL compensation from undercoupling is limited, since a sufficient attenuation range cannot be maintained if the couplers deviate too much from the 3dB point. The Φ_{bias} therefore can be adjusted to control the amount of polarization dependence in ΔΦ for a given attenuation range. Experimentally, we have determined that for an attenuation range of 10 dB, the PDL can be kept to below 0.5dB if the coupler balance is undercoupled between −0.5 dB, and −2 dB and Φ_{bias} is around 0.75π. As shown in FIG. 4A, for the example previously discussed, given a coupler balance of −1.5 dB to −0.5 dB, and an arm difference of 0.75 (λ₀/2n), the PDL is reduced by matching the polarization curves as closely as possible.

Bar Path Example

For sufficiently similar couplers, the equation governing the light transmission of TE and TM polarizations to the bar path is given below:

$${I}_{TE}^{-} = {cos}^{2} ( 2 {φ}_{TE} ) {cos}^{2} ( \frac{{Δϕ}_{TE}}{2} ) + {sin}^{2} ( \frac{{Δϕ}_{TE}}{2} )$$

$${I}_{TM}^{-} = {cos}^{2} ( 2 {φ}_{TM} ) {cos}^{2} ( \frac{{Δϕ}_{TM}}{2} ) + {sin}^{2} ( \frac{{Δϕ}_{TM}}{2} )$$

The PDL for the bar path is as follows:

$$PDL ( dB ) = - 10 log [ \frac{{I}_{TM}^{-}}{{I}_{TE}^{-}} ] = - 10 log [ \frac{{cos}^{2} ( 2 {φ}_{TM} ) {cos}^{2} ( \frac{{Δϕ}_{TM}}{2} ) + {sin}^{2} ( \frac{{Δϕ}_{TM}}{2} )}{{cos}^{2} ( 2 {φ}_{TE} ) {cos}^{2} ( \frac{{Δϕ}_{TE}}{2} ) + {sin}^{2} ( \frac{{Δϕ}_{TE}}{2} )} ]$$

For Δφ close to II, the PDL is relatively insensitive; for Δφ close to 0, the PDL becomes much more sensitive since both the numerator and the denominator are small.

$$\text{:} 0 < Δϕ < π , {cos}^{2} ( \frac{{Δϕ}_{TM}}{2} ) < {cos}^{2} ( \frac{{Δϕ}_{TE}}{2} ) ,$$

In this above equation, in order to achieve low PDL, it is necessary that cos²(2Φ_{TM})>cos²(2Φ_{TE}). For couplers close to 3 dB in balance, the phases should be Φ_{TM}>Φ_{TE}>II/4, which means that the couplers should be overcoupled. Experiments show that with a coupler balance in the range of 0.5 dB and 1.5 dB, together with φ_{bias}=0.5π, the PDL can be kept to below 0.5 dB for an attenuation range of 10 dB. As shown in FIG. 4B, for the example previously discussed, given a coupler balance of 0.5 dB and 1.5 dB, and an arm difference of 0.5(λ₀/2n), the PDL is reduced by matching the polarization curves as closely as possible.

As will be apparent to one skilled in the art, the VOA's of the present invention may be incorporated with other optical devices (e.g., optical switches, passive waveguides, arrayed waveguide grating wavelength multiplexers and demultiplexers, waveguide optical amplifiers, optical waveguide splitters, etc.)

We claim:

1. An optical device having a Mach-Zehnder, the device comprising:
a first optical waveguide and a second optical waveguide, each optical waveguide having an input port and output port;
a first optical coupling region wherein a portion of said first waveguide and a portion of said second waveguide are positioned adjacent to one another to provide optical coupling between said portions of said waveguides, a length of said waveguides within said coupling region, a width of each respective waveguide within said coupling region, and a separation between said waveguides within said coupling region defining a first coupler balance;
a second optical coupling region wherein a portion of said first waveguide and a portion of said second waveguide are positioned adjacent to one another to provide optical coupling between said portions of said waveguides, a length of said waveguide within said coupling region, a width of each respective waveguide within said coupling region, and a separation between said waveguides within said coupling region defining a second coupler balance;
an active region between said first coupling region and said second coupling region wherein in said active region said first waveguide and said second waveguide each comprise a first and second arm, said waveguides are positioned adjacent to one another to provide substantially no optical coupling between said portions of said waveguides, a portion of one of said first waveguides in said active region defines an optical path length of a first arm and a portion of said second waveguide in said active region comprises an optical path of the second arm;
wherein said optical path length of the first arm and said optical path length of the second arm are unequal; and
wherein the coupler balance of at least one of the coupling regions is substantially non-zero in value.

2. The optical device of claim 1 wherein the coupler balance of the first coupling region is substantially equal to the coupling balance of the second coupling region.

3. The optical device of claim 1 further comprising at least one optical path length adjuster on at least one of said first and second waveguides in said active region, said optical path length adjuster adapted to change the respective optical path length of the respective arm.

4. The optical device of claim 3 wherein each arm further includes said optical path length adjuster.

5. The optical device of claim 3 wherein said optical path length adjuster changes said respective optical path length of the respective arm according to the voltage applied to the optical path length adjuster.

6. The optical device of claim 5 wherein said optical path length adjuster comprises a resistive metal film adapted to provides a temperature difference between the two waveguides according to the voltage applied to the optical path length adjuster and thereby changes the optical path length of one arm to a greater extent than it changes the optical path length of the other arm.

7. A variable optical attenuator (VOA) comprising the optical device of claim 3 wherein said first optical waveguide input port comprises an input port of the VOA and said first optical waveguide output port comprises an output port of the VOA.

8. The VOA of claim 7 adapted such that a zero-voltage attenuation, of the VOA is between a maximum attenuation and a minimum attenuation attainable by the VOA.

9. The VOA of claim 7 adapted such that a zero-voltage attenuation of the VOA is greater than a minimum attenuation by between 2 to 10 dB.

10. The VOA of claim 9 adapted such that a coupler balance of each of said coupler regions is between 0.2 to 2.5 dB.

11. A variable optical attenuator (VOA) comprising the optical device of claim 3 wherein said first optical waveguide input port comprises an input port of the VOA and said second optical waveguide output port comprises an output port of the VOA.

12. The VOA of claim 8 adapted such that a zero-voltage attenuation of the VOA is between a maximum attenuation and a minimum attenuation attainable by the VOA.

13. The VOA of claim 8 adapted such that a zero-voltage attenuation of the VOA is greater than a minimum attenuation by between 5 to 15 dB.

14. The VOA of claim 13 adapted such that a coupler balance of each of said coupler regions is between 0.1 to 2.5 dB.

15. The VOA of claim 12 adapted such that a coupler balance of each of said coupler regions is between −2.5 to −0.2 dB.

16. The VOA of claim 7, 8, 9, 11, 12, 13 or 15 adapted such that in a zero-voltage state of the VOA, a difference between said optical path of the first arm and said optical path length of the second arm is non-zero.

17. A combination variable optical attenuator system, the combination comprising:
at least one variable optical attenuator as described in any of claims 1-5, the attenuator being disposed on a substrate; and,
an optical device disposed on the substrate and in optical communication with the attenuator, the optical device being selected from the group consisting of optical switches, passive waveguides, arrayed waveguide grating wavelength multiplexers and demultiplexers, waveguide optical amplifiers, and optical waveguide splitters.

18. An array of variable optical attenuators comprising:
a plurality of input waveguides disposed in parallel on a substrate;
a plurality of attenuators, each as described in any of claims 1-5 and optically connected to a corresponding input waveguide; and
a plurality of output waveguides optically connected to a corresponding attenuator.

19. A method for reducing polarization dependent loss in a variable optical attenuator device having a Mach-Zehnder configuration, where said variable optical attenuator includes a first and second optical waveguide for transmitting an optical signal in each respective waveguide, at least one coupling region, and a phase shifting region between said coupling region, the method comprising:
configuring at least one coupling region to have a non-zero coupler balance; and
selecting an optical path length difference between the first waveguide and the second waveguide to induce a non-zero phase difference between optical signals.

20. The method of claim 19 configuring at least one coupling region comprises configuring a coupling length, a coupling width, a coupling gap, or a combination thereof to achieve the non-zero coupler balance.

21. The method of claim 19 wherein selecting an optical path difference between the first waveguide and the second waveguide comprises configuring a width, a length, or a combination thereof to induce the non-zero phase difference.
